(19) United States
(12) Patent Application Publication
(10) Pub. No.: US 2007/0002864 A1
(43) Pub. Date: Jan. 4, 2007

(54) Transmission system and method for radio link protocol

(75) Inventors: Seung June Yi, Seoul (KR); Su-Lin Low, San Diego, CA (US)

Correspondence Address: Howard Chen, Esq.;Preston Gates & Ellis LLP, Suite 1700, 55 Second Street, San Francisco, CA, 94105, US

(73) Assignee: VIA Telecom Co., Ltd.

(21) Appl. No.: 11/448,226

(22) Filed: Jun. 7, 2006

Related U.S. Application Data
(60) Provisional application No. 60/690,331, filed on Jun. 13, 2005.

(51) Int. Cl. H04L 12/56

(52) U.S. Cl. 370/394; 370/310

(57) ABSTRACT

The present invention discloses a system and method for eliminating useless waiting and needless packet retransmission in a radio link protocol (RLP) system having a RLP sender and a RLP receiver with one or more reception buffers, the method comprising checking for any missing packet upon receiving a transmission by the RLP receiver, sending one or more negative acknowledgements (Naks) for every missing packet to the RLP sender by the RLP receiver, retransmitting by the RLP sender only packets requested by one or more negative acknowledgements (Naks) when the RLP sender also receives a transmission suspension request, and receiving transmissions by the RLP receiver after the transmission suspension request has been sent out by the RLP receiver.

### CROSS REFERENCE

This application claims the benefits of U.S. patent application Ser. No. 60/690,331, which was filed on Jun. 13, 2005 and entitled “RLP flow control enhancement”.

### BACKGROUND

The present invention relates generally to wireless communication protocols, and more particularly, to the operation of radio link protocol (RLP) for packet communications.

RLP (Radio Link Protocol) is one of the application layer protocols of a 1xHRPD (High Rate Packet Data) system that provides an octet stream service with an acceptably low error rate for efficient operation of higher layer protocols. To achieve a low radio link error rate, RLP uses negative acknowledge (Nak) based retransmission, and duplicate detection functions.

As packets of octets are buffered and transmitted in sequence, if a RLP receiver receives a new packet that doesn't follow an earlier sequence number, then the RLP receiver will send a Nak message to request a re-transmission of the missing packets. Sequential octets are delivered to a higher layer, but packets following a missing one will be stored in a reception buffer. But in some cases, the reception buffer is overloaded due to large numbers of octets that need to be stored or a stack of the delivery of octets to the higher layer. As a result, the RLP system has to suspend further transmissions to flush out the reception buffer.

Traditionally, during the suspension, both the RLP sender and receiver enter a ‘Close’ state, i.e., the RLP sender stops transmission, and the RLP receiver stops receiving any transmission. But flushing out the reception buffer can not happen right away, as it has to wait for the Nak abort timer to expire. This delay is normal for the RLP system in an ‘Open’ state because the missing octets could be retransmitted later. But in ‘Close’ state, since the RLP transmission is blocked, it is useless for the RLP receiver to wait for the timer to expire. Waiting for the expiration of the Nak timer delays the flushing of the reception buffer, and hence lowers the RLP transmission rate.

Besides, the Nak requested missing packets will be retransmitted after the RLP sender goes back to the ‘Open’ state, but the RLP receiver will only discard them because the RLP receiving window has already advanced to a higher sequence number. This useless retransmission wastes radio resource and reduces transmission efficiency.

As such, what is needed is a method for eliminating useless waiting and retransmission in the RLP transmission.

### SUMMARY

In view of the foregoing, a system and method are disclosed for eliminating useless waiting and needless packet retransmission in a radio link protocol (RLP) system having a RLP sender and a RLP receiver with one or more reception buffers. The method comprises checking for any missing packet upon receiving a transmission by the RLP receiver, sending one or more negative acknowledgements (Naks) for every missing packet to the RLP sender by the RLP receiver, retransmitting by the RLP sender only packets requested by one or more negative acknowledgements (Naks) when the RLP sender also receives a transmission suspension request, and receiving transmissions by the RLP receiver after the transmission suspension request has been sent out by the RLP receiver.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 shows a part of components of a RLP system.

FIG. 2 is a flow chart illustrating steps taken in a normal RLP transmission encountering a missing packet.

FIG. 3 is a flow chart illustrating steps taken in a traditional RLP system when a transmission encounters a reception buffer overloading.

FIG. 4 is a flow chart illustrating steps taken in a RLP system dealing with a reception buffer overloading by retransmitting only missing packets according to one embodiment of the present invention.

FIG. 5 is a flow chart depicting an alternative method of dealing with a reception buffer overloading by ignoring missing packets according to another embodiment of the present invention.

### DESCRIPTION

The present invention discloses methods to enhance transmission efficiency in radio link protocol (RLP) systems.

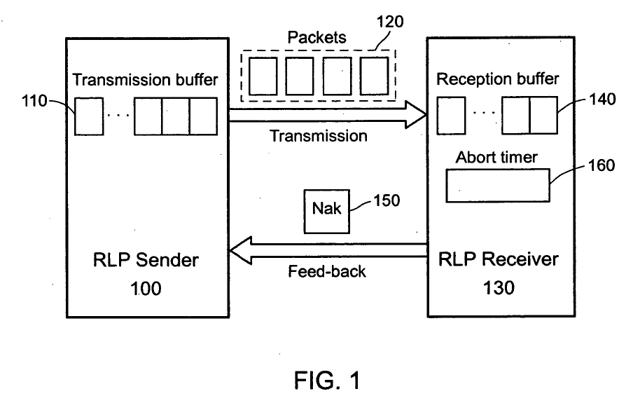

FIG. 1 shows a part of components of a (Radio Link Protocol) RLP system. A RLP sender 100 receives octets, or byte of data, for transmission from a higher layer, and stores them sequentially in the transmission buffer 110. For transmission, the RLP sender 100 forms a RLP packet 120 by concentrating the RLP packet header with a number of received contiguous octets. The RLP packet header includes the RLP sequence number that indicates the sequence number of the first octet in a RLP payload. The formed RLP packets 120 are then transmitted to an RLP receiver 130 through a radio interface. The transmitted packets 120 are still stored in the transmission buffer 110 after the radio transmission for the provision of possible retransmission.

The RLP receiver 130 receives RLP packets from an RLP sender 100 through the radio interface. If the sequence number of the received RLP packet 120 is consecutively following the sequence number of the last delivered octet, then the RLP receiver 130 delivers the received octets sequentially to a higher layer. But if the sequence number is not consecutive, then the received octets are stored in a reception buffer 140 with location indicated by the sequence number. The RLP receiver 130 sends a negative acknowledge (Nak) message 150 to the RLP sender 100 requesting a retransmission of all the missing RLP packets 120. Meanwhile the RLP receiver 130 sets a Nak abort timer 160 for each packet requested in the Nak message 150 for a predefined period. Upon receiving the Nak message 150, the RLP sender 100 transmits the requested packets to the RLP receiver 130. The stored octets are delivered to the higher layer only after all the previous octets are delivered to the higher layer, or the Nak abort timers 160 for each missing packet have expired.

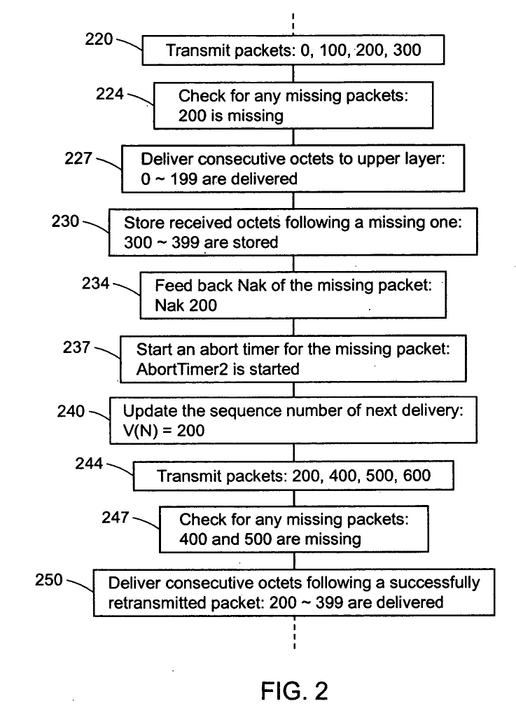

FIG. 2 is a flow chart for illustrating steps taken in a normal RLP transmission encountering a missing packet. A RLP sender transmits four packets in step 220 with sequence number starts at 0, 100, 200 and 300, respectively. Upon receiving a transmission, a RLP receiver checks for any missing packets in step 224, and finds packet 200 is missing. Consecutive octets 0˜199 are delivered to a higher layer in step 227. While received octets following a missing packet, 300˜399, are stored in a reception buffer in step 230. Then the RLP receiver feed back a Nak message requesting a retransmission of the missing packet 200 in step 234. An abort timer, AbortTimer2, will be started for the missing packet 200 in step 237. A sequence number for next delivery to the higher layer will then be updated to V(N)=200 in step 240.

Referring to FIG. 2, in the next transmission step 244, packet 200 is retransmitted along with three new packets, 400, 500 and 600. The RLP receiver checks for any missing packet in step 247, and finds packet 600 is missing, but packet 200 is successfully retransmitted. Then the RLP receiver delivers all the consecutive octets including the stored octets following the successfully retransmitted packets in step 250.

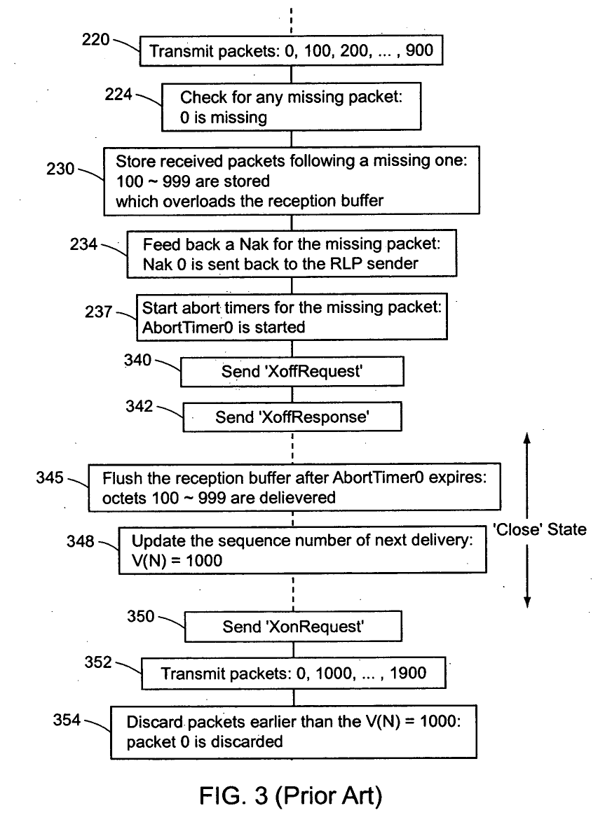

FIG. 3 is a flow chart for illustrating steps taken in a traditional RLP system when a transmission encounters a reception buffer overloading due to large numbers of octets needed to be stored or a stack of the delivery of octets to the higher layer. Note that like steps in these and following figures are labeled with like reference numbers, and are therefore not discussed in detail again.

Referring to FIG. 3, since a first packet 0 is missing in a transmission in steps 220 and 224, a large number of octets, 100˜999, need to be stored which overloads the reception buffer of the RLP receiver in step 230. As normal, the RLP receiver feeds back Nak 0 in step 234, and starts an abort timer in step 237. In order to flush out all the content of the reception buffer, the RLP receiver needs to suspend further transmissions. The RLP receiver first sends a ‘XoffRequest’ command to request the RLP sender to stop further transmission in step 340. Upon receiving the ‘XoffRequest’, the RLP sender will send a ‘XoffResponse’ command to the RLP receiver in step 342. Then both the RLP sender and receiver enter a ‘Close’ state. Meanwhile the RLP receiver delivers the stored octets, 100˜999, to the higher layer after the abort timer, AbortTimer0, expires in step 345, and then updates the sequence number of next delivery to V(N)=1000 in step 348. This delay is normal for the RLP in Open state because the missing octets could be retransmitted later. But in Close state, since the RLP transmission is blocked, it is useless for the RLP receiver to wait for the timer to expire.

After the RLP sender flushes out its reception buffer, it will send a ‘XonRequest’ command to the RLP sender to request continuation of transmission in step 350. Then the RLP sender starts to transmit packets 0, 1000, . . . , 1900 in step 352. The packet 0 is retransmitted because it is missing during the previous transmission prior to the ‘Close’ state, and a Nak 0 request has been sent to the RLP sender. But since the sequence number of next delivery, V(N)=1000, has passed that of packet 0, then the retransmitted packet 0 will just be discarded in step 354. This useless retransmission wastes radio resource and reduces transmission efficiency.

So the conventional RLP transmission method has these two problems, i.e., the abort timer's fruitless wait during a ‘Close’ state, and useless retransmission of packets missing prior to the ‘Close’ state. They lower the RLP transmission rate and efficiency.

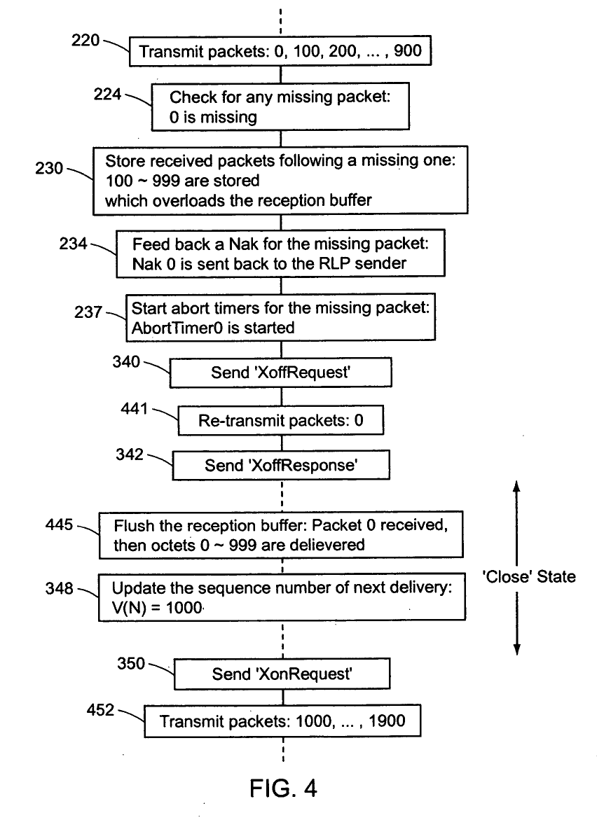

FIG. 4 is a flow chart illustrating steps taken in the RLP system dealing with a reception buffer overloading by retransmitting only missing packets according to one embodiment of the present invention. Again, the packet 0 is missing in a transmission of packets 0˜900 in steps 220 and 224. Octets 100˜999 need to be stored, which overloads the reception buffer in step 230. Nak 0 is sent back to the RLP sender in step 234. The AbortTimer0 is started for the missing packet 0 in step 237. Even though the RLP receiver sends a ‘XoffRequest’ command to request the RLP sender to stop transmission in step 340, the RLP sender still retransmits packet 0 as requested by the Nak 0, in step 441. Then the RLP sender send out a ‘XoffResponse’ command in step 342, letting both the RLP sender and receiver enter a ‘Close’ state. The retransmitted packet 0 is successfully received, so the octets, 0˜999, are delivered to the higher layer during the ‘Close’ state as shown in step 445. As before, the sequence number of next delivery is updated to V(N)=1000 in step 348. When the RLP system re-enters the ‘Open’ state by sending a ‘XonRequest’ command by the RLP receiver in step 350, only new packets 1000, . . . , 1900 are transmitted in step 452.

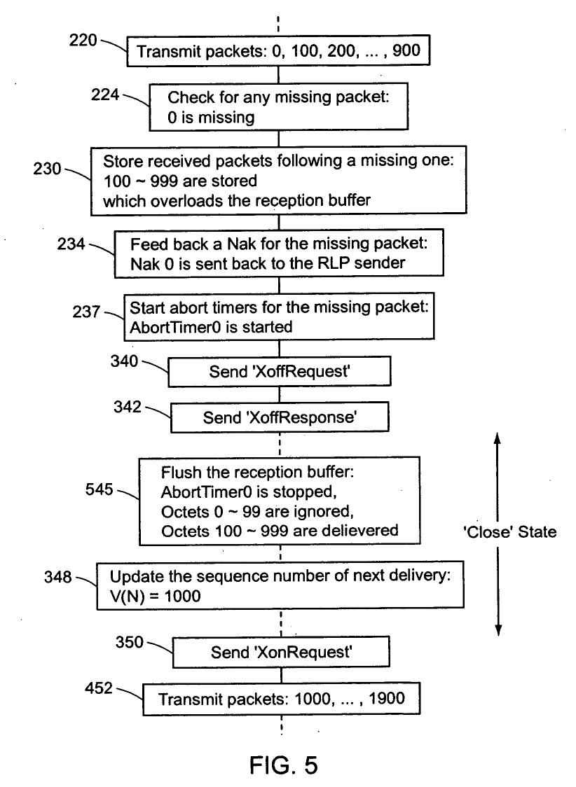

FIG. 5 is a flow chart depicting an alternative method of dealing with the reception buffer overloading by ignoring missing packets according to another embodiment of the present invention. Again, the packet 0 is missing in a transmission of packets 0˜900 in steps 220 and 224. Octets 100˜999 need to be stored, which overloads the reception buffer in step 230. Nak 0 is sent back to the RLP sender in step 234. The AbortTimer0 is started for the missing packet 0 in step 237. However when the RLP receiver sends a ‘XoffRequest’ command, the RLP sender will respond with a ‘XoffResponse’ command without any packet transmission as shown in steps 340 and 342. In the ‘Close’ state, the RLP receiver stops the AbortTimer0, ignores missed octets 0˜99, and delivers the stored octets, 100˜999 to the higher layer as shown in step 545. Again, when the RLP system re-enters the ‘Open’ state on the ‘XonRequest’ in step 350, only new packets 1000, . . . , 1900 are transmitted in step 452.

Referring back to FIG. 1, the steps shown in FIG. 4 are embedded in the RLP transmission system hardware. The RLP sender 100 has at least one transmission buffer for storing transmitted packets for provisioning possible retransmission. The RLP sender 100 is configured to retransmit only packets requested by one or more negative acknowledgements (Naks) 150 upon receiving a transmission suspension request. The RLP receiver 130 is configured to receive only the retransmitted packets after the transmission suspension request is being sent by the receiver. The RLP receiver 130 has one or more reception buffers 140 configured to store the transmitted packets following one or more missing packets, in this case, i.e., at least one packet is missing, the RLP receiver 130 sends corresponding Naks 150 to the RLP sender 100. In case the transmitted packets that need to be stored overload the reception buffers 140, the RLP receiver 130 sends the transmission suspension request to the RLP sender. When the reception buffers 140 are flushed out, the RLP receiver 130 will send a resume transmission request to the RLP sender, which is configured to transmit only packets that have not been previously transmitted.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A method for eliminating useless waiting and needless packet retransmission in a radio link protocol (RLP) system having a RLP sender and a RLP receiver with one or more reception buffers, the method comprising:
checking for any missing packet upon receiving a transmission by the RLP receiver;
sending one or more negative acknowledgements (Naks) for every missing packet to the RLP sender by the RLP receiver;
retransmitting by the RLP sender only packets requested by the Naks when the RLP sender also receives a transmission suspension request; and
receiving retransmitted packets by the RLP receiver after the transmission suspension request has been sent out by the RLP receiver.

2. The method of claim 1 further comprising storing transmitted packets in a transmission buffer in the RLP sender for provisioning possible retransmission.

3. The method of claim 1 further comprising:
storing the transmitted packets following a missing packet in the reception buffers in the RLP receiver; and
sending the transmission suspension request by the RLP receiver when the transmitted packets that need to be stored overload all the reception buffers.

4. The method of claim 1 further comprising transmitting only packets that have not been previously transmitted by the RLP sender upon receiving a request to resume transmission.

5. A method for eliminating useless waiting in a radio link protocol (RLP) receiver with one or more reception buffers when all the reception buffers are overloaded with transmitted packets following a missing packet, the method comprising:
stopping an abort timer started for the missing packet;
ignoring the missing packet; and
delivering all the contiguous packets that have been successfully transmitted and are stored in the reception buffers to a higher layer.

6. The method of claim 5, wherein the delivering further comprises updating a sequence number of next delivery to a number representing a packet following the delivered transmitted packets.

7. The method of claim 5 further comprising sending a transmission suspension request to a RLP sender by the RLP receiver.

8. The method of claim 7 further comprising sending one or more negative acknowledgements (Naks) for every missing packet to the RLP sender by the RLP receiver.

9. The method of claim 8 further comprising discarding any negative acknowledgement (Nak) requesting retransmission of a missing packet by the RLP sender upon receiving the transmission suspension request.

10. The method of claim 7 further comprising:
suspending further transmissions by the RLP sender upon receiving the transmission suspension request; and
transmitting only packets that have not been previously transmitted upon receiving a request to resume transmission by the RLP sender.

11. A radio link protocol (RLP) system, comprising:
A RLP sender configured to retransmit only packets requested by one or more negative acknowledgements (Naks) upon receiving a transmission suspension request; and
a RLP receiver configured to receive retransmitted packets after the transmission suspension request is being sent by the receiver, further comprising:
one or more reception buffers configured to store the transmitted packets following one or more missing packets;
means for sending the Naks if any missing packets are found; and
means for sending the transmission suspension request when the transmitted packets that need to be stored overload the reception buffers.

12. The system of claim 11, wherein the sender further comprises one or more transmission buffers for storing transmitted packets for provisioning possible retransmission.

13. The system of claim 11, wherein the sender is further configured to transmit only packets that have not been previously transmitted upon receiving a request to resume transmission.
